(19) United States
(12) Patent Application Publication
(10) Pub. No.: US 2025/0376883 A1
(43) Pub. Date: Dec. 11, 2025

(54) ENCLOSURE CONFIGURATION SYSTEMS AND METHODS

(71) Applicant: AA Integra LLC, Seattle, WA (US)

(72) Inventor: Aram STEPANIAN, Seattle, WA (US)

(73) Assignee: AA Integra LLC, Seattle, WA (US)

(21) Appl. No.: 19/229,792

(22) Filed: Jun. 5, 2025

Related U.S. Application Data
(60) Provisional application No. 63/656,511, filed on Jun. 5, 2024.

(51) Int. Cl. E05D 15/26; E05D 15/24

(52) U.S. Cl. CPC E05D 15/262; E05D 15/242; E05D 15/264; E05Y 2900/106

(57) ABSTRACT

Methods and systems (e.g. as kits, installations, or other protocols) are described in relation to lockable hinges for use in panelized enclosures. A system includes a plurality of purpose-built lockable hinges each configured to connect two adjacent panels. When the hinges are in a locked state the adjacent panels may move along a track together. In an unlocked state the panels may move toward or away from each other along the track. The method may include kit installation or otherwise controlling the selective movement of door panels, such as for turning a fenced and ventilated enclosure into a structure with a retractable door that (externally and superficially) seems conventional.

### RELATED APPLICATIONS

This application claims priority to U.S. Prov. Pat. App. 63/656,511 (“IMPROVED ENCLOSURE CONFIGURATION SYSTEMS AND METHODS”) filed 5 Jun. 2024, incorporated by reference herein to the extent not inconsistent herewith.

### FIELD OF INVENTION

The present disclosure generally relates to mechanical systems for panelized enclosures, and more specifically, to systems, methods, and devices that utilize lockable hinges to facilitate adjustable positioning and securement of panels of such enclosures.

### BACKGROUND

Panelized enclosures, such as garage or shed doors, are commonly used in residential and commercial settings to provide security and protection from environmental elements. These enclosures typically include several panels that are interconnected by hinges, allowing the enclosure to be opened or closed.

Conventional hinges are mechanical devices that connect two solid objects, allowing for a limited angle of rotation between them. In the context of panelized enclosures, they allow for the movement of individual panels relative to each other, enabling (part of) the enclosure to be opened or closed.

In addition to hinges, panelized enclosures often incorporate other components such as wheels, tracks, and door locks. Wheels are typically used to facilitate the movement of the enclosure along a track. Tracks guide the movement of wheels attached to a garage or shed door, ensuring that it opens and closes in a controlled manner. The choice of these components, their material composition, and their manufacturing methods can greatly affect the performance and functionality of the enclosure.

### BRIEF DESCRIPTION OF THE DRAWINGS

Non-limiting and non-exhaustive examples are described with reference to the following figures.

FIG. 1 illustrates a system comprising some or all components of a panelized enclosure in which one or more improved technologies may be incorporated.

FIG. 2 illustrates another such system in which one or more improved technologies may be incorporated, with some or all components in a locked state in which one or more improved technologies may be incorporated.

FIG. 3 illustrates another configuration like that of FIG. 1 or 2, having one or more components now in an unlocked state.

FIG. 4 illustrates yet another configuration like that of FIG. 1 or 2, having one or more components now in a partially open state with a containment fence in which one or more improved technologies may be incorporated.

FIG. 5 illustrates a lockable hinge in situ in which one or more improved technologies may be incorporated.

FIG. 6 illustrates the lockable hinge of FIG. 5 in a transitional state, in which one or more improved technologies may be incorporated.

FIG. 7 illustrates another system having a lockable hinge in which one or more improved technologies may be incorporated.

FIG. 8 illustrates a “retrofit-type” kit in which one or more improved technologies may be incorporated.

FIG. 9 illustrates a “professional-install-type” kit in which one or more improved technologies may be incorporated.

FIG. 10 illustrates a brace for preventing panel movement in which one or more improved technologies may be incorporated.

FIG. 11 illustrates a system having one or more safety features in which one or more improved technologies may be incorporated, optionally as an instance of other systems described herein.

FIG. 12 illustrates a variant of one or more of the above systems featuring a front view of a supplemental bias unit in which one or more improved technologies may be incorporated.

FIG. 13 illustrates an enclosure configuration method in which one or more improved technologies may be incorporated.

### DETAILED DESCRIPTION

The detailed description that follows is represented largely in terms of processes and symbolic representations of structures or operations by conventional components. It is intended that the terminology used in the description presented below be interpreted in its broadest reasonable manner, even though it is being used in conjunction with a detailed description of certain example embodiments. Although certain terms may be emphasized below, any terminology intended to be interpreted in any restricted manner will be overtly and specifically defined as such.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

“Above,” “actuated,” “along-track,” “as,” “associated,” “at least,” “away,” “back,” “both,” “bottom,” “by,” “clamped,” “conventional,” “coupled,” “first,” “herein,” “lateral,” “lockable,” “low,” “manually,” “more,” “of,” “otherwise,” “protruding,” “rotatably,” “second,” “slidable,” “supported,” “upward,” “wherein,” “without,” or other such descriptors herein are used in their normal yes-or-no sense, not merely as terms of degree, unless context dictates otherwise.

In light of the present disclosure, those skilled in the art will understand from context what is meant by “supported” and by other such structural descriptors used herein. As used herein “causing” is not limited to a proximate cause but also enabling, conjoining, or other actual causes of an event or phenomenon. “To” is not used to articulate a mere intended purpose in phrases like “configured to,” moreover, but is used normally, in descriptively identifying special purpose structures and arrangements.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

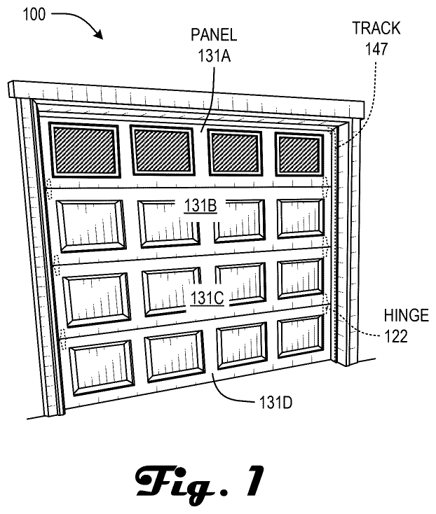

Referring now to FIG. 1 there is shown an installed and operational system 100 in use as garage (or shed) door. When the panels 131A-D are raised with all such hinges 122 coupling adjacent pairs of the panels, wheels in a vicinity of each hinged joint guide each panel along the track and then following a curve of each corresponding track 147 so that the panels 131A-D arrive at a substantially horizontal, fully raised position. (It will be understood for present purposes, that mirror image counterparts may provide nominally identical support on the left side as is described on the right.)

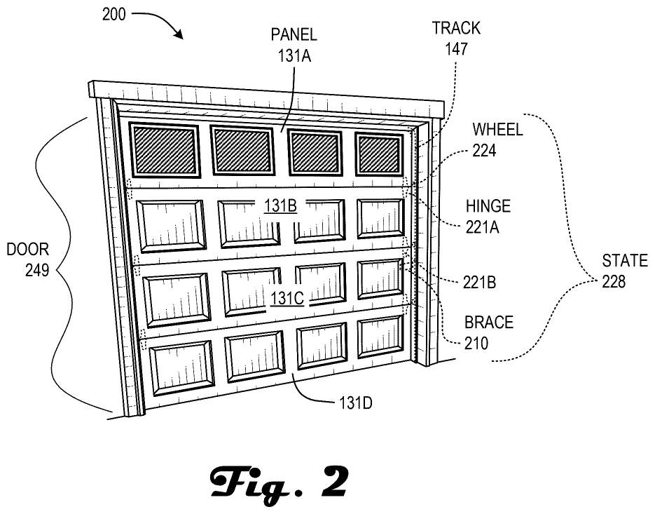

Referring now to FIG. 2 there is shown another installed and operational system 200, one in which one or more improved technologies may be implemented in regard to a door 249 comprising several panels 131A-D. In a first retrofit upgrade a matched pair of conventional hinges 122 both spanning panels 131A-B have been replaced with a corresponding pair of purpose-built lockable hinges 221A that likewise span panels 131A-B when those panels are raised and lowered together (with the purpose-built lockable hinges 221B therebetween in a locked state 228).

Likewise in a second retrofit upgrade a matched pair of conventional hinges 122 each spanning panels 131B-C have been replaced with a corresponding pair of purpose-built lockable hinges 221B that likewise span panels 131B-C when those panels are raised and lowered together (with the purpose-built lockable hinges 221B therebetween in a locked state 228). As used herein a “lockable” hinge is one in which at least one side is designed to be reversibly transitioned between locked and unlocked states, whether or not it is currently locked or installed. A conventional garage door hinge not designed to be unlocked in situ is not “locked” or “lockable” merely by installation.

More generally a panel door hinge allows one of its sides to pivot freely relative to the other even after being mounted on respective panels. As used herein a hinge side is “lockable” if it has a locked state in which its components are reversibly coupled and an unlocked state in which its components are nondestructively uncoupled. Unlike purpose-built lockable hinges 221, as used herein a conventional panel door hinge is not “configured to” have a (selectively and reversibly) lockable side.

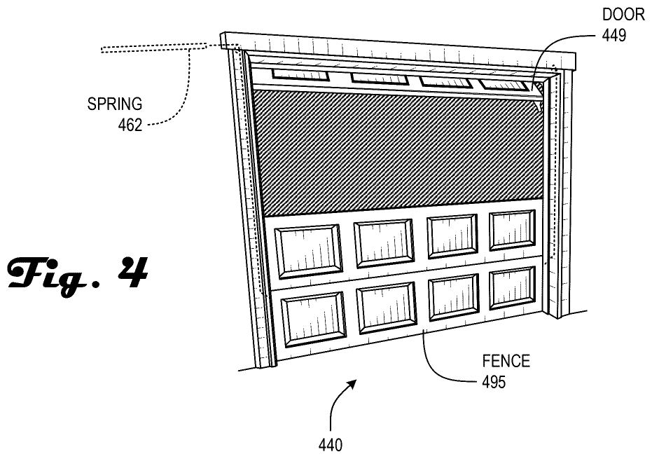

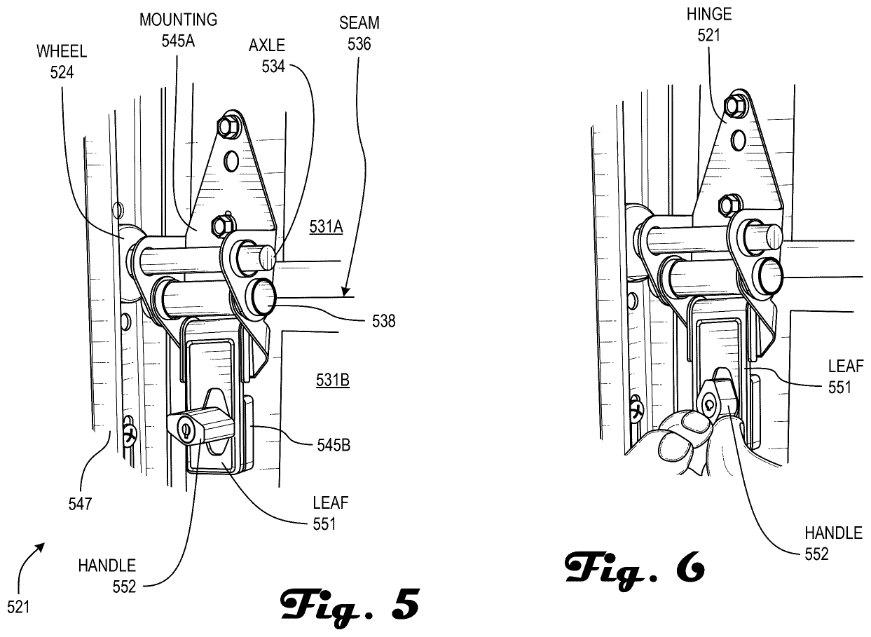

With hinges 221A on the lower half of panel 131A each in an unlocked state and a suitably mounted wheel 224 (see FIG. 5) guiding each lower half of panel 131A upward, panel 131A can retract away from the other panels 131B-D along its corresponding track 147 and into a fully upraised position. In some variants one or more braces 210 secure those panels 131B-D in their lowered position to overcome a conventional bias spring (see FIG. 4) that would otherwise resist the separation. This can occur, for example, in context in which each brace 210 affixes an end of one of the remaining panels 131 to its corresponding track 147 and in which the conventional bias springs are left attached during the separation. See FIG. 9.

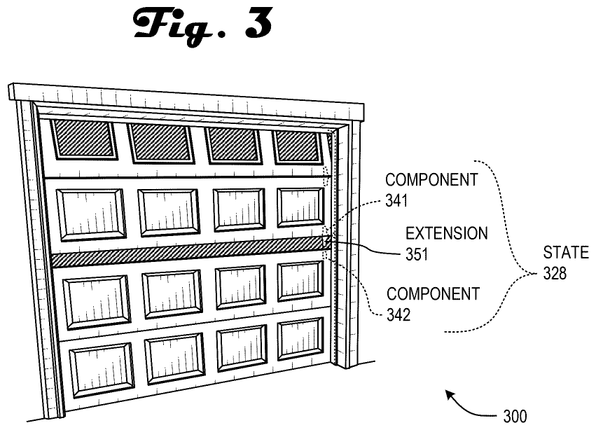

Referring now to FIG. 3 there is shown a system 300 that optionally implements a reconfiguration of system 200. As shown a pair of purpose-built lockable hinges 221B that normally span adjacent panels 131B-C when in a locked state 228 are shown each in an unlocked state 328 that allows a first component 341 mounted to one of the panels 131B to separate from a second component 342 (of each of the hinges 221B) mounted to another of the panels 131C as shown. This can occur, for example, in a context in which adjacent panels 131B-C are likewise configured to establish an unlocked state 328 that allows them to separate, in which an extension 351 of one of the components is aligned to be locked with or unlocked from the other component, in which panel 131B thereby moves in an along-track direction away from adjacent lower panel 131C, and in which the lower panel 131C can thereby remain stationary and lowered as shown during such movement. In some variants, for example, one or more braces 210 hold the lowest panel(s) 131C-D in a lowermost position to prevent a raising force upon the upper panels from moving upward with the upper panels.

Referring now to FIG. 4 there is shown a structure 440 that may be implemented using the system 300 of FIG. 3 in an arrangement in which both lower panels 131C-D are fully lowered and thereby configured as a (retractable) fence 495. The fence 495 is longer than 3 meters and taller than 1 meter as shown. With one or more upper panels 131A-B retracted, the garage or shed has now transitioned from a closed space into an open-air structure 440 ideal for containing pets or children and for fencing out others. If additional lockable hinges 221A are also installed as described above moreover, the open-air structure 440 can be altered to provide a taller fence 495 merely by repositioning installed components, without altering the installation. This can be accomplished by switching the state 228, 328 and position (of installed lockable kit or hinge components 341, 342) of the above-described systems 100, 200, 300 in situ, without disassembly. See FIGS. 5-11. In some variants, moreover, a conventional spring that biases a bottom panel upward can remain attached to a bottom panel 131D that remains fully lowered (e.g. by use of one or more braces 210) even while a partial door 449 is raised.

Referring again to FIGS. 1-4, a method is described for configuring panels of a door for fencing and ventilation. The method includes configuring first and second purpose-built lockable hinges 121B each to span adjacent upper and lower door panels 131B-C in lieu of first and second conventional hinges 122 wherein the first lockable hinge 121B comprises a first component mounted to the upper door panel 131B and a second component mounted to the lower door panel 131C and wherein an extension 351 of the first component mounted to the upper door panel 131B is configured to be locked with and unlocked from the second component mounted to the lower door panel 131C.

The method may also include configuring the first component (directly or otherwise) to rotatably engage a first wheel support axle that engages a first wheel 124 so as to allow the first wheel 124 to roll along a first door track 147 while guiding upward movement of the upper door panel 131B when the first and second lockable hinges 121B are in an unlocked state 228 wherein at least the lower door panel 131C is configured to remain in a lowered position during the upward movement of the upper door panel 131B. This can occur, for example, in a context in which a brace 125 forces the lower door panel 131C (directly or otherwise) to remain lowered. By this configuration a locked state 128 of the first and second lockable hinges 121B allows the upper and lower door panels 131B-C of the garage door system 100, 200 to undergo along-track movement together and an unlocked state 228 thereof allows the upper door panel 131B to rise while at least the lower door panel 131C serves as a divider or containment fence 495.

Referring now to FIG. 5 there is shown another lockable hinge 521 suitable for use in the above-described systems 100, 200, 300. A solid mounting 545A is rigidly affixed (e.g. with adhesive or screws) to a lower half of an “upper” panel 531A so as to support a hinge pin 538 at the seam 536 between the upper and lower panel 531A-B (i.e. centered within 5 millimeters) and also supports an in-track wheel axle 534 above the seam 536. This can occur, for example, in a context in which the wheel axle 534 supports a corresponding wheel 524 that can roll up or down a track 147, 547; in which a leaf 551 or other extension 351 engages a (plate or other) lower mounting 545B affixed to “upper” panel 531B; and in which a handle 552 or other actuator of the lower mounting 545B is below the seam 536 and movable relative to another part of the lower mounting 545B; and in which such movement completes the locking or unlocking operation that modifies the state 228, 328 of a lockable hinge 221, 521. Hinge 521 is “lockable” by virtue of a panel door hinge side—comprising mounting 545B, leaf 551, and handle 552—configured to undergo a nondestructive transition from a fully unlocked state to a fully locked state and back.

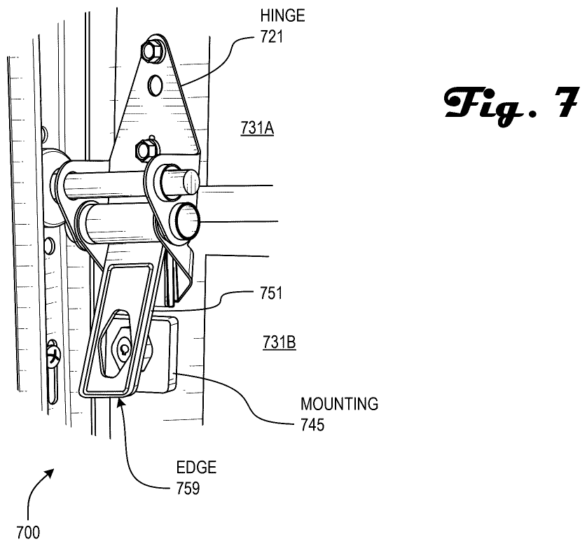

Referring now to FIG. 6 there is shown the lockable hinge 521 of FIG. 5 in a transitional state, with handle 552 manually turned to a vertical position to facilitate disengagement of leaf 551 and handle 552.

Referring now to FIG. 7 there is shown a system 700 having (an upper mounting of) a lockable hinge 721 spanning adjacent upper and lower panels 731A-B like those of FIGS. 1-5. But in this variant it depicts a leading edge 759, leaf 751, or other extension 351 that is biased away from panel 731B and toward a horizontally offset position relative to that of its corresponding mounting 745. This can be implemented by cantilevering/bending leaf 751 or biasing it as shown (or both). Alternatively or additionally such biasing may be accomplished by repelling magnets or a normally compressed spring (or both).

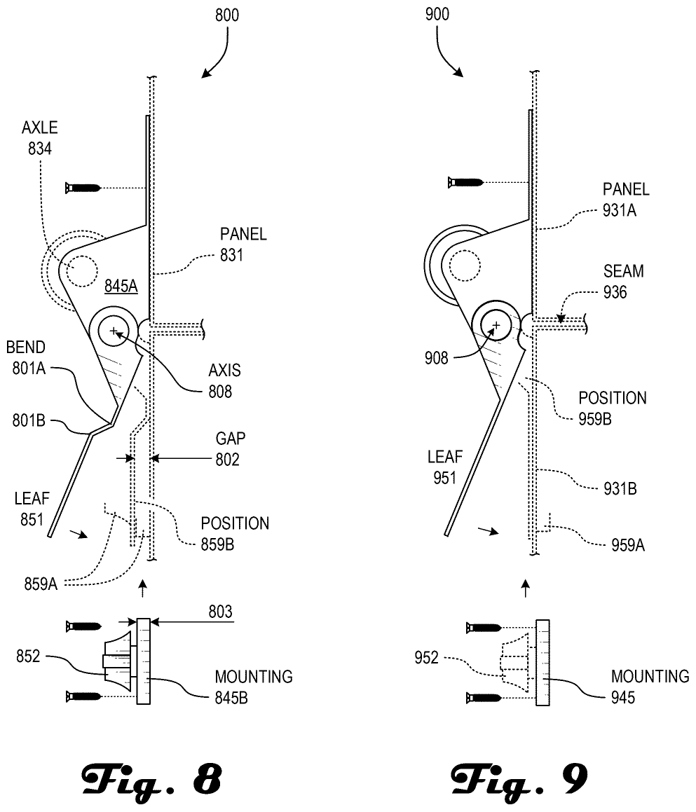

Referring now to FIG. 8 there is shown a kit 800 that is suitable for use in a retrofit-type configuration for use with upper and lower adjacent door panels 831. As shown kit 800 includes two mountings 845A-B for each hinge. The “upper” mounting 845A includes a leaf 851 that is pivotable about axis 808 so that (a gravitational or other biasing provides) its leading edge being more than 1 centimeter away from the panels 831 when released. See FIG. 7. This allows clearance for a “lower” mounting 845B that is configured to be superficially mounted onto a “lower” door panel 131B-D, 531B as described herein.

The “lower” mounting 845B may include a clip or handle 852 as shown to ensure secure hinge engagement. In some variants each such “lower” mounting 845B may be superficially affixed to an indoor panel surface with little or no layer cutting, as a replacement for a conventional hinge. And leaf 851 as shown features two bends 801A-B so that a resulting gap 802 accommodates the thickness 803 of the lower mounting 845B protruding as shown. When installing kit 800, mounting 845A is affixed to an upper panel 831. Mounting 845B is affixed to an adjacent lower panel at position 859A (e.g. with screws) as shown. Thereafter leaf 851 can be pivoted (counterclockwise about axis 808 as shown) downward into a position 859B that is (nominally) adjacent to mounting 845B and locked. Alternatively or additionally, such an “upper” mounting 845A may include or rotatably engage an axle 834 for a first wheel near a seam that is (nominally) aligned with the axis 808 of the “upper” mounting 845A as shown, so that the first wheel can guide the “upper” panel as it rolls along a track 147, 547. This can occur, for example, in a context in which the axle 834 is centered at or above the seam one a lower half of the upper panel 831.

Referring now to FIG. 9 there is shown a kit 900 that is adapted for use in an expert install or factory build for upper and lower adjacent door panels 931A-B. As shown kit 900 includes two mountings 945. The “upper” mounting 945 includes a leaf 951 pivotable about an axis 908 so that (at least a leading edge of) it hangs away from the “lower” panel 931B like that of FIG. 8. As shown the “lower” mounting 945 is configured to occupy an interior of the “lower” door panel 931B (at position 959A) allowing for a smaller clearance. Such an internal or flush mounting can simplify the job of the upper mounting (e.g. by removing the need for bends 801A-B) and allow for low-clearance mechanisms (e.g. a releasable buckle or magnetic latch) in place of handle 952. Either way, part of the upper mounting extends into a position 959B adjacent the mounting 945 or panel 931B (or both). As used herein a clearance is “low” if it protrudes less than 1.5 centimeters from a panel.

Alternatively or additionally, an “upper” mounting 945 may include or rotatably engage an axle 934 for a first wheel (having an axis of rotation nominally) less than 20 centimeters above a seam 936 so that the first wheel can guide the “upper” panel 931A as it rolls along a track 147, 547 away from the “lower” panel 931B.

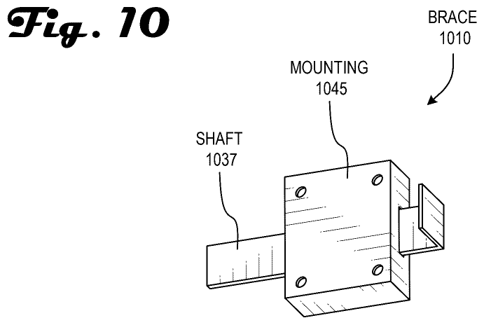

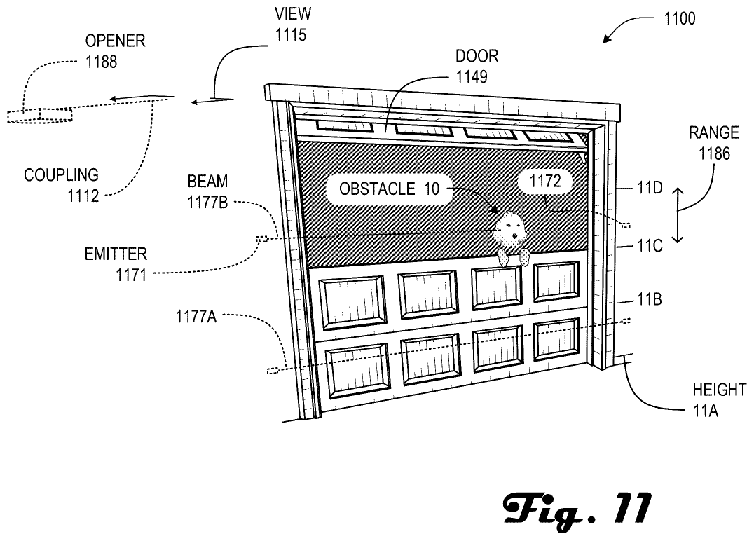

Referring now to FIG. 10 there is shown a brace 1010 having a shaft 1037 that is laterally slidable through a mounting 1045 affixed to a lower panel 131, 531, 731, 831, 931. When shaft 1037 is inserted into a corresponding hole in a stationary track 147, 547. The mounting 1045 affixed to the lower panel and the shaft 1037 of the brace 1010 together prevent the lower panels 131C, 531B, 731B, 931B from being moved upward by a door spring.

Referring now to FIG. 11 there is shown a system 1100 configured as an open-air structure 440 having a reconfigurable closable door 1149 (e.g. switchable between a complete door state as shown in FIG. 2 or a partial door state as shown in FIG. 4) having one or more safety features. As shown a motorized door opener 1188 is configured to close door 1149 conditionally, partly based on whether doing so would (apparently) be safe and partly based on a user activating the opener 1188 (e.g. via a wireless handheld or mounted control, not shown). Similar openers conventionally operate with a chain or cable coupling to an extension 351 of a topmost panel of a complete door 249 configured to drive the complete door 249 between open and closed states. Such setups use as a commonplace first safety feature a pair of optical components positioned generally between a ground height 11A and a lowest seam height 11B between the bottom and adjacent panels. At this range of heights a child or pet passing below a closing complete door 249 will typically break the beam 1177A and thereby cause the closing to stop or reverse. An unbroken beam 1177A signals a safe condition in the context of a complete door 249, thereby allowing the complete door 249 to lower completely to the ground height 11A.

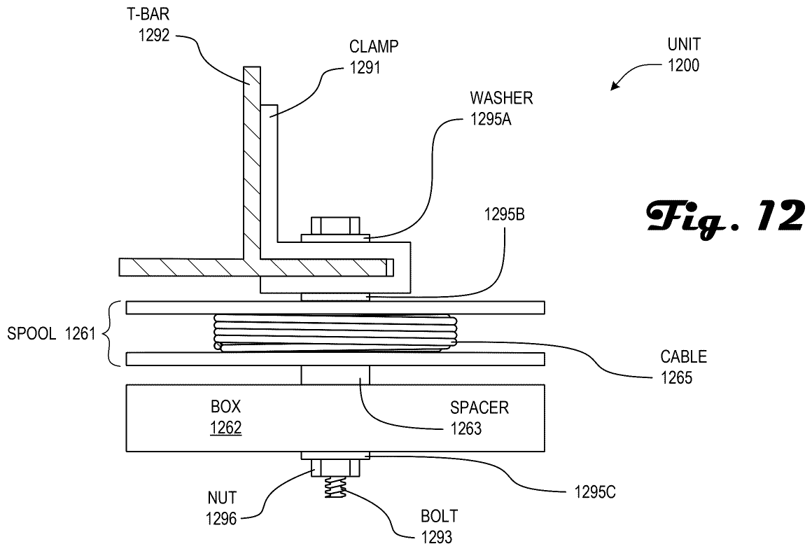

But with a partial door 1149 that beam 1177A is at an unsuitable height. Accordingly as an optional second safety feature a higher pair of optical components (e.g. an emitter 1171 aligned with a sensor 1172) at a suitable height range 1186 to detect a child or other animate obstacle 10 that may be leaning over a fence 495 formed by one or more stationary bottom panels 131D. Such a suitable range 1186, for a separated door, is between a height 11C of a fence top and a maximum height 11D as shown 10 to 100 centimeters higher than the fence top. If a beam 1177B in that height range 1188 encounters an obstacle 10 as shown right above a panel fence top, an unsafe condition is detected. Opener 1188 is operably coupled to the corresponding sensor 1172 so that it will stop or reverse a closing partial door 449, 1149 as an automatic and conditional response to the above-fence beam 1177B being broken. Alternatively or additionally, system 1100 may incorporate a motor protection feature mounted in a position that is (at least laterally) between the opener 1188 and the door 1149 as shown. See FIG. 12 for a view 1115 of this feature.

FIG. 12 illustrates a front view of a supplemental bias unit 1200 affixed to a T-Bar shown in cross-section (e.g. in a front view 1115 like that of FIG. 11). In such contexts one or more primary springs 462 are prevented from functioning when one or more bottom panels 131D are clamped at a fully lowered position (e.g. by one or more braces 210) so that such springs 462 cannot help (a motor of) opener 1188 to lift a partial door 449, 1149. Having one or more such bias units 1200 installed protects opener 1188 from excessive strain, especially in a case of an after-market install featuring an older opener 1188 not designed to lift panels without the aid of a spring. A bias unit may, for example, be installed onto a ceiling or permanent fixture by suitable mounting hardware—e.g. with a bolt 1293 and nut 1296 and with washers 1295A-C to allow rotation.

For example when a partial or complete door 249, 1149 operably coupled to unit 1200 descends, cable 1265 unwinds incrementally from spool 1261 and a rotary assembly comprising spool 1261, spacer 1263, and part of the spring box 1262 rotates about bolt 1293. This causes (one or more springs within) the spring box 1262 to become increasingly loaded, reducing an initial burden on an opener 1188 configured to mitigate a weight of one or more panels 131A-B of a partial door 449, 1149 significantly (i.e. by more than 25%). This reduces undue wear that would otherwise result from significant and repeated force pulses in starting upward door motions (e.g. without a primary spring) for which a given opener 1188 was not designed.

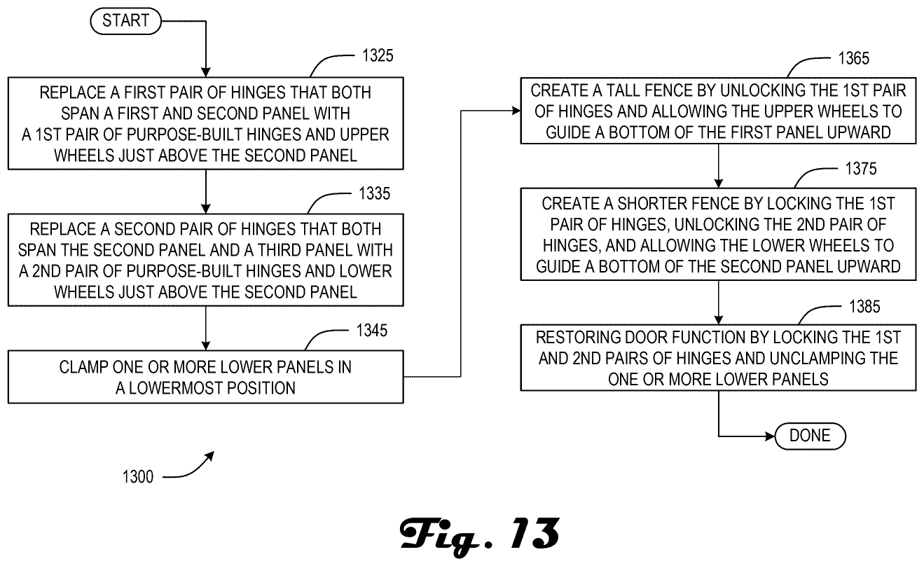

Referring now to FIG. 13 there is shown an operational flow 1300. After a start operation, operation 1325 describes replacing a first pair of hinges that both span a first and second panel with a first pair of purpose-built hinges and upper wheels just above the second panel (e.g. starting a retrofit by replacing a conventional first pair of hinges that both connect a first panel 131A with a second panel 131B using a first pair of purpose-built hinges 221A that rotatably support a matched pair of upper wheels 224, 524 so that they each have an axis of rotation less than 20 centimeters above a top edge of the second panel 131B).

Operation 1335 describes replacing a second pair of hinges that both span the second panel and a third panel with a second pair of purpose-built hinges and lower wheels just above the second panel (e.g. replacing a conventional second pair of hinges that both span the second panel 131B and a third panel 131C with a second pair of purpose-built hinges 221B and a matched pair of lower wheels 224, 524 so that they each have an axis of rotation less than 20 centimeters above a top edge of the third panel 131C).

Operation 1345 describes manually or otherwise clamping one or more lower panels in a lowermost position (e.g. directly or otherwise restricting a movement of at least panel 131D as shown in FIGS. 1-3). See FIG. 10.

Operation 1365 describes creating a tall fence by unlocking the first pair of hinges and allowing the upper wheels to guide a bottom of the first panel upward (e.g. creating a fence taller than 1.5 meters that includes at least three panels 131B-D by unlocking the first pair of purpose-built hinges 221A and allowing the upper wheels 224, 524 to guide a bottom half of the first panel 131A upward).

Operation 1375 describes creating a shorter fence by locking the first pair of hinges, unlocking the second pair of hinges, and allowing the lower wheels to guide a bottom of the second panel upward (e.g. creating a shorter fence 495 by locking the first pair of purpose-built hinges 221A, unlocking the second pair of purpose-built hinges 221B, and allowing the lower wheels 224, 524 to guide a bottom half of the second panel 131B upward). This can occur, for example, in a context in which the second panel 131B would otherwise be damaged by dangling downward when the first and second panels 131A-B are fully raised away from panels 131C-D and in which the first and second panels 131A-B can thereafter only achieve a (nominally) horizontal position when all the panels 131A-D are locked together.

Operation 1385 describes restoring or establishing door function by locking the first and second pairs of hinges and unclamping the one or more lower panels (e.g. removing the tall or shorter fence 495 by lowering the upper panels 131A-B, locking the first and second pairs of purpose-built hinges 221A-B to connect each corresponding adjacent panels pivotably along each corresponding seam between panels, and unclamping the one or more lower panels 221C-D by releasing brace 210).

Some methods described herein include configuring a pair of purpose-built hinges 221B to span an upper and lower adjacent panels 131, 831 and a matched pair of wheel supports so that wheels 224, 524 rotatably supported thereby will each have an axis of rotation (e.g. about an axle 534, 834 coupled to a wheel 224, 524) less than 20 centimeters above a bottom edge of the upper panel 131A-C, 931A. When installed this will allow one or more corresponding lower panels to be clamped at a fully lowered position so that they remain lowered while the wheels 224, 524 (in a corresponding track 147, 547) protect the upper panel 131A-C, 931A by guiding a bottom half of the upper panel 131A-C, 931A as it travels upward away from the corresponding adjacent lower panel. Various systems 100, 200, 300, 700, 1100 and kits 800, 900 that are configured to facilitate such methods are likewise described.

In some variants a particular system 100, 200, 300, 700, 1100 comprises first and second lockable hinges 121B that are each configured to span upper and lower door panels 131B-C, 531, 731, 931 wherein the first lockable hinge 121B comprises a first (assembly or other) component mounted to the upper door panel 131B, 531A, 731A, 931A and a second (assembly or other) component mounted to the lower door panel 131C, 531B, 731B, 931B and wherein an extension 351 of the first component mounted to the upper door panel 131B, 531A, 731A, 931A is configured to be locked to the second component mounted to the lower door panel 131C.

This can occur, for example, in a context in which the first component (directly or otherwise) is configured to rotatably engage a first wheel support axle 534, 934 that engages a first wheel 124 so as to allow the first wheel 124 to roll along a first door track 147 while guiding upward movement of the upper door panel 131B, 531A, 731A, 931A when the first and second lockable hinges 121B are in an unlocked state 228 and in which at least the lower door panel 131C is configured to be restricted in a lowered position during the upward movement of the upper door panel 131B. In some variants, for example, a brace 210, 1010 in a top half of the topmost unmoving panel 131, 531, 731, 831, 931 is configured to restrict the topmost unmoving panel 131, 531, 731, 831, 931 against a drifting misalignment between the separated panels that would otherwise hinder rejoining the separated panels.

### CLAUSES

Clause 1. A system 100, 200, 300, 700, 1100 for reversibly configuring a panel door 249, 449, 1149 for fencing and ventilation, the system comprising:
(at least) first and second lockable hinges 221A, 221B each configured to span adjacent upper and lower door panels 131B-C, 531, 731, 931 of the panel door 249 wherein the first lockable hinge 221B comprises a first component 341 configured to be mounted to the upper door panel 131B, 531A, 731A, 931A and a second component 342 configured to be mounted to the lower door panel 131C, 531B, 731B, 931B.

Clause 2. The system of any of the above clauses configured to replace two or more conventional hinges 122 of an existing door installation as a retrofit kit 800, 900 that also includes a bias unit 1200 configured to assist a motorized door opener 1188 in lifting the upper door panel 131B, 531A, 731A, 931A away from the lower door panel 131C, 531B, 731B, 931B so as to extend an operational longevity of the motorized door opener 1188.

Clause 3. The system of any of the above clauses configured to replace two or more conventional hinges 122 of an existing door installation as a retrofit kit 800, 900 that also includes a pair of optical components configured to be installed above the stationary divider or containment fence 495 by a positive distance less than 50 centimeters, the pair being configured so that a closing partial door 449, 1149 will break the beam therebetween and thereby stop or reverse direction and thereby protect a child or other animate obstacle 10 from a closing-garage-door injury.

Clause 4. The system of any of the above clauses wherein the stationary divider or containment fence 495 establishes a retractable barrier that is both taller than 1 meter and longer than 3 meters having multiple lower door panels remain in their lowermost position with an opening taller than 10 centimeters above the stationary divider or containment fence 495.

Clause 5. The system of any of the above clauses wherein the lockable hinges are configured to allow axial movement tolerance larger than 1 millimeter and less than 10 centimeters to accommodate misalignment between the upper and lower door panels 131B-C, 531, 731, 931 during operation.

Clause 6. The system of any of the above clauses wherein the first wheel support axle 534, 834, 934 is positioned less than 20 centimeters above a top edge of the lower door panel 131C, 531B, 731B, 931B to facilitate guided movement of the upper door panel 131B, 531A, 731A, 931A along the door track 147, 547.

Clause 7. The system of any of the above clauses comprising a brace 210, 1010 configured to restrict movement of at least one lower door panel 131C, 531B, 731B, 931B in a fully lowered position wherein the brace 210, 1010 includes a laterally slidable shaft 1037 configured to slide into a corresponding opening in the door track 147, 547 to prevent upward movement of at least the lower door panel 131C, 531B, 731B, 931B.

Clause 8. The system of any of the above clauses comprising a supplemental bias unit 1200 configured to assist in lifting multiple panels of a partial door 449, 1149 wherein the supplemental bias unit 1200 includes a spring box 1262 and a cable 1265 coupled to a spool 1261 and wherein the supplemental bias unit 1200 is configured to reduce an initial lifting burden on a motorized door opener 1188 by more than 25%.

Clause 9. The system of any of the above clauses comprising:
a bias unit 1200 that includes a spring box 1262 configured to provide a maximum static load upon a cable 1265 that is configured to lift a partial door 1149 that includes at least the upper door panel 131B, 531A, 731A, 931A wherein the bias unit 1200 protects the garage door opener 1188 from damage by significantly reducing a tension pulse magnitude upon the garage door opener 1188 (i.e. by more than 5%) the partial door 1149 begins to separate from the lower door panel 131C, 531B, 731B, 931B.

Clause 10. The system of claim 1, wherein the first component 341 comprises:
a solid first mounting 545A configured to be rigidly affixed to a lower half of the upper door panel 131B, 531A, 731A, 931A;
a hinge pin 538 supported by the solid first mounting 545A and positioned at a seam 536 (e.g. aligning by less than 5 mm vertically) between the upper and lower panels 131B-C, 531, 731, 931; and
an in-track wheel axle 534 supported by the solid first mounting 545A above the seam 536 wherein the in-track wheel axle 534 is configured to support a corresponding wheel 524 that can roll up or down a track 147, 547.

Clause 11. The system of any of the above clauses wherein the second component 232, 342 comprises:
a first mounting 545A configured to be affixed to an upper door panel 131B, 531A, 731A, 931A;
a leaf 551 or other extension 351 supported by the first mounting 545A; and
a handle 552 or other actuator of a second mounting 545B affixed to a lower door panel 131C, 531B, 731B, 931B and movable relative to another part of the second mounting 545B.

Clause 12. The system of any of the above clauses wherein movement of a handle 552 or other actuator completes a locking or unlocking operation that modifies the state 228, 328 of the lockable hinge 521 and wherein the handle 552 may be manually turned to a (nominally) vertical position to facilitate disengagement of a leaf 551 and handle 552.

Clause 13. The system of any of the above clauses comprising:
a motorized door opener 1188 configured to selectively open and close a partial door 449, 1149 that includes the upper door panel 131B, 531A, 731A, 931A but not the lower door panel 131C, 531B, 731B, 931B;
a first pair of optical safety components positioned in a height range between a ground height 11A and a lowest seam height 11B, the first pair configured to emit and detect a first beam 1177A to signal a safe condition for closing the complete door 249; and
a second pair of optical safety components (e.g. an emitter 1171 and sensor 1172 in alignment) positioned in a height range 1186 between a fence top height 11C and a maximum height 11D that is 10 to 100 centimeters higher than the fence top height 11C, the second pair configured to emit and detect a second beam 1177B;
wherein the motorized door opener 1188 is operably coupled to a sensor 1172 of the second pair and configured (e.g. via circuitry of the door opener 1188) to stop or reverse closing of the partial door 449, 1149 as an automatic and conditional response to the second beam 1177B encountering an optical obstacle 10 (apparently) positioned above the containment fence 495.

Clause 14. The system of any of the above clauses comprising:
a bias unit 1200 mounted at least partly between the motorized door opener 1188 and a partial door 449, 1149 that includes the upper door panel 131B, 531A, 731A, 931A but not the lower door panel 131C, 531B, 731B, 931B wherein the bias unit 1200 comprises:
a spool 1261 configured to wind and unwind a cable 1265;
a spring box 1262 containing one or more springs;
a rotary assembly comprising the spool 1261 and part of the spring box 1262, the rotary assembly configured to rotate about a mounting bolt 1293; and
mounting hardware including the mounting bolt 1293 and a nut 1296 configured to affix the bias unit 1200 to a ceiling or permanent fixture.

Clause 15. The system of any of the above clauses comprising:
a bias unit 1200 mounted in a vicinity (e.g. with a separation less than 3 meters) of the motorized door opener 1188 wherein the bias unit 1200 is configured to reduce an initial burden on the motorized door opener 1188 by more than 25% when lifting one or more panels of the partial door 449, 1149 and wherein a first spring box 1262 of the bias unit 1200 is configured to become increasingly loaded as the cable 1265 unwinds and as the partial door 449, 1149 lowers.

Clause 16. The system of any of the above clauses configured to replace two or more conventional hinges 122 of an existing panel door installation as a retrofit kit 800 that also includes an upper mounting 545A, 845A configured to be affixed to the upper door panel 131B, 531A, 731A, 931A and a lower mounting 545B, 845B configured to be affixed to the lower door panel 131C, 531C, 731C, 931C.

Clause 17. The system of any of the above clauses configured to replace two or more conventional hinges 122 of an existing panel door installation as a retrofit kit 800 that also includes an upper mounting 545A, 845A configured to be affixed to the upper door panel 131B, 531A, 731A, 931A and a lower mounting 545B, 845B configured to be affixed to the lower door panel 131C, 531C, 731C, 931C wherein the upper mounting 845A includes a leaf 851 that is pivotable about an axis 808 and biased so that a leading edge thereof is positioned more than 1 centimeter away from the panels 831 when released and wherein the leaf 851 features two bends 801A-B that create a resulting gap 802 to accommodate a thickness 803 of the lower mounting 845B.

Clause 18. The system of any of the above clauses configured to replace two or more conventional hinges 122 of an existing panel door installation as a retrofit kit 800 that also includes an upper mounting 545A, 845A configured to be affixed to the upper door panel 131B, 531A, 731A, 931A and a lower mounting 545B, 845B configured to be affixed to the lower door panel 131C, 531C, 731C, 931C wherein the lower mounting 845B is configured to be superficially affixed to an indoor panel surface (e.g. at position 859A) and wherein the leaf 851 is configured to be later pivoted downward into a position 859B that is adjacent to the lower mounting 845B and locked thereto.

Clause 19. The system of any of the above clauses configured to replace two or more conventional hinges 122 of an existing panel door installation as a retrofit kit 800 that also includes an upper mounting 545A, 845A configured to be affixed to the upper door panel 131B, 531A, 731A, 931A and a lower mounting 545B, 845B configured to be affixed to the lower door panel 131C, 531C, 731C, 931C wherein the upper mounting 845A includes or rotatably engages an axle 834 for a first wheel, the axle 834 being centered at or above a seam on a lower half of the upper panel 831 and aligned with the axis 808 of the upper mounting 845A and wherein the first wheel may guide the upper door panel 131B, 531A, 731A, 931A as the first wheel rolls along a (nominally) vertical track 147, 547.

Clause 20. The system of any of the above clauses configured as a kit 900 (e.g. for use by an expert or in a factory) comprising first and second mountings 945 wherein the first mounting 945 is configured to occupy an interior of the lower door panel 131C, 531B, 731B, 931B configured (e.g. at position 959A) to allow for a leaf-panel clearance smaller than 1 millimeter and wherein the upper mounting 945 includes a leaf 951 pivotable about an axis 908 so that at least a leading edge thereof is configured to hang freely (using a gravitational bias) more than 2 centimeters away from the lower door panel 131C, 531B, 731B, 931B.

Clause 21. The system of any of the above clauses wherein an upper mounting 945 includes or rotatably engages an axle 834 for a first wheel having an axis of rotation that is 2 to 20 centimeters above an inter-panel seam 936 so that the first wheel may guide the upper door panel 131B, 531A, 731A, 931A while rolling along a track 147, 547 generally upward relative to the lower door panel 131C, 531B, 731B, 931B.

Clause 22. The system of any of the above clauses wherein an extension 351 of the first component 341 mounted to the upper door panel 131B, 531A, 731A, 931A is configured to be locked with and unlocked from the second component 342 mounted to the lower door panel 131C, 531B, 731B, 931B.

Clause 23. The system of any of the above clauses wherein the first component 341 is configured to rotatably engage a first wheel support axle 534, 834, 934 that engages a first wheel 124, 224, 524 so as to allow the first wheel 124, 224, 524 to roll along a door track 147, 547 while guiding upward movement of the upper door panel 131B, 531A, 731A, 931A when the first and second lockable hinges 221A, 221B are in an unlocked state 328.

Clause 24. The system of any of the above clauses wherein a locked state 228 of the first and second lockable hinges 221A, 221B allows the upper and lower door panels 131B-C, 531, 731, 931 to undergo along-track movement together and an unlocked state 328 thereof allows the upper door panel 131B, 531A, 731A, 931A to rise while at least the lower door panel 131C, 531B, 731B, 931B is configured as (at least part of) a stationary divider or containment fence 495.

While various system, method, article of manufacture, or other embodiments or aspects have been disclosed above, also, other combinations of embodiments or aspects will be apparent to those skilled in the art in view of the above disclosure. The various embodiments and aspects disclosed above are for purposes of illustration and are not intended to be limiting. With respect to methods described herein those skilled in the art will appreciate that recited operations therein may generally be performed in any order. Also, although various operational flows are presented in sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise.

1. A system for reversibly configuring a panel door for fencing and ventilation, said system comprising:
first and second lockable hinges each configured to span adjacent upper and lower door panels of said panel door in lieu of conventional hinges therebetween wherein said first lockable hinge comprises a first component configured to be mounted to said upper door panel and a second component configured to be mounted to said lower door panel;
wherein an extension of said first component mounted to said upper door panel is configured to be locked with and unlocked from said second component mounted to said lower door panel; and
wherein a locked state of said first and second lockable hinges allows said upper and lower door panels to undergo along-track movement together and an unlocked state thereof allows said upper door panel to rise while at least said lower door panel is configured as a stationary divider or containment fence.

2. The system of claim 1 configured to replace two or more conventional hinges of an existing door installation as a retrofit kit that also includes a bias unit configured to assist a motorized door opener in lifting said upper door panel away from said lower door panel so as to extend an operational longevity of said motorized door opener.

3. The system of claim 1 configured to replace two or more conventional hinges of an existing door installation as a retrofit kit that also includes a pair of optical components configured to be installed above said stationary divider or containment fence by a positive distance less than 50 centimeters, said pair being configured so that a closing partial door will break a beam therebetween and thereby stop or reverse direction and thereby protect a child or other animate obstacle from a closing-garage-door injury.

4. The system of claim 1 wherein said stationary divider or containment fence establishes a retractable barrier that is both taller than 1 meter and longer than 3 meters having multiple lower door panels remain in their lowermost position with an opening taller than 10 centimeters above said stationary divider or containment fence.

5. The system of claim 1 wherein said lockable hinges are configured to allow axial movement tolerance larger than 1 millimeter and less than 10 centimeters to accommodate misalignment between said upper and lower door panels during operation.

6. The system of claim 1 wherein said first wheel support axle is positioned less than 20 centimeters above a top edge of said lower door panel to facilitate guided movement of said upper door panel along said door track.

7. The system of claim 1 comprising a brace configured to restrict movement of at least one lower door panel in a fully lowered position wherein said brace includes a laterally slidable shaft configured to slide into a corresponding opening in said door track to prevent upward movement of at least said lower door panel.

8. The system of claim 1 comprising a supplemental bias unit configured to assist in lifting multiple panels of a partial door wherein said supplemental bias unit includes a spring box and a cable coupled to a spool and wherein said supplemental bias unit is configured to reduce an initial lifting burden on a motorized door opener by more than 25%.

9. The system of claim 1 comprising:
a bias unit that includes a spring box configured to provide a maximum static load upon a cable that is configured to lift a partial door that includes at least said upper door panel wherein said bias unit protects said garage door opener from damage by significantly reducing a tension pulse magnitude upon said garage door opener as said partial door begins to separate from said lower door panel.

10. The system of claim 1, wherein said first component comprises:
a solid first mounting configured to be rigidly affixed to a lower half of said upper door panel;
a hinge pin supported by said solid first mounting and positioned at a seam between said upper and lower panels; and
an in-track wheel axle supported by said solid first mounting above said seam wherein said in-track wheel axle is configured to support a corresponding wheel that can roll up or down a track.

11. The system of claim 1 wherein said second component comprises:
a first mounting configured to be affixed to an upper door panel;
a leaf or other extension supported by said first mounting; and
a handle or other actuator of a second mounting affixed to a lower door panel and movable relative to another part of said second mounting wherein movement of a handle or other actuator completes a locking or unlocking operation that modifies said state of said lockable hinge and wherein said handle may be manually turned to a vertical position to facilitate disengagement of a leaf and handle.

12. The system of claim 1 comprising:
a motorized door opener configured to selectively open and close a partial door that includes said upper door panel but not said lower door panel;
a first pair of optical safety components positioned in a height range between a ground height and a lowest seam height, said first pair configured to detect a first beam to signal a safe condition for closing a complete door that includes said upper and lower door panels; and
a second pair of optical safety components positioned in a height range between a fence top height and a maximum height that is 10 to 100 centimeters higher than said fence top height, said second pair configured to detect a second beam;
wherein said motorized door opener is operably coupled to a sensor of said second pair and configured to stop or reverse closing of said partial door as an automatic and conditional response to said second beam encountering an optical obstacle positioned above said containment fence.

13. The system of claim 1 comprising:
a bias unit mounted at least partly between said motorized door opener and a partial door that includes said upper door panel but not said lower door panel wherein said bias unit comprises:
a spool configured to wind and unwind a cable;
a spring box containing one or more springs;
a rotary assembly comprising said spool and part of said spring box, said rotary assembly configured to rotate about a mounting bolt; and
mounting hardware including said mounting bolt and a nut configured to affix said bias unit to a ceiling or permanent fixture.

14. The system of claim 1 comprising:
a bias unit mounted in a vicinity of said motorized door opener wherein said bias unit is configured to reduce an initial burden on said motorized door opener by more than 25% when lifting one or more panels of said partial door and wherein a first spring box of said bias unit is configured to become increasingly loaded as a cable biased by said first spring unwinds and as said partial door lowers.

15. The system of claim 1 configured to replace two or more conventional hinges of an existing panel door installation as a retrofit kit that also includes an upper mounting configured to be affixed to said upper door panel and a lower mounting configured to be affixed to said lower door panel.

16. The system of claim 1 configured to replace two or more conventional hinges of an existing panel door installation as a retrofit kit that also includes an upper mounting configured to be affixed to said upper door panel and a lower mounting configured to be affixed to said lower door panel wherein said upper mounting includes a leaf that is pivotable about an axis and biased so that a leading edge thereof is positioned more than 1 centimeter away from said panels when released and wherein said leaf features two bends that create a resulting gap to accommodate a thickness of said lower mounting.

17. The system of claim 1 wherein an upper mounting includes or rotatably engages an axle for a first wheel having an axis of rotation that is 2 to 20 centimeters above an inter-panel seam so that said first wheel may guide said upper door panel while rolling along a track generally upward relative to and away from said lower door panel.

18. A system for reversibly configuring a panel door, said system comprising:
first and second lockable hinges each configured to span adjacent upper and lower door panels of said panel door in lieu of conventional hinges therebetween wherein said first lockable hinge comprises a first component configured to be mounted to said upper door panel and a second component configured to be mounted to said lower door panel and wherein an extension of said first component is configured to be locked with and unlocked from said second component.

19. The system of claim 18 wherein at least said lower door panel is configured to remain in a fully lowered position during an upward movement of said upper door panel; wherein said first component is configured to rotatably engage a first wheel support axle that engages a first wheel so as to allow said first wheel to roll along a door track while guiding upward movement of said upper door panel when said first and second lockable hinges are in an unlocked state; and wherein a locked state of said first and second lockable hinges allows said upper and lower door panels to undergo along-track movement together and an unlocked state thereof allows said upper door panel to rise while at least said lower door panel is configured as a stationary divider or containment fence.

20. A method of making a system for reversibly configuring a panel door for fencing and ventilation, said method comprising:
configuring first and second lockable hinges each to span adjacent upper and lower door panels of said panel door in lieu of conventional hinges therebetween wherein said first lockable hinge comprises a first component configured to be mounted to said upper door panel and a second component configured to be mounted to said lower door panel and wherein an extension of said first component is configured to be locked with and unlocked from said second component.
